(19) United States
(12) Patent Application Publication
(10) Pub. No.: US 2015/0142577 A1
(43) Pub. Date: May 21, 2015

(54) PUBLIC MOBILE ADVERTISEMENT MOBILE DISTRIBUTE DEVICE

(71) Applicant: BroadFast Mobile Media Corporation, Taipei (TW)

(72) Inventor: Chia-Hung Kao, Taipei (TW)

(21) Appl. No.: 14/527,879

(22) Filed: Oct. 30, 2014

(30) Foreign Application Priority Data
Nov. 21, 2013 (TW) 102221826

(51) Int. Cl. G06Q 30/02

(52) U.S. Cl. CPC G06Q 30/0267; G06Q 30/0257
USPC 705/14.64

(57) ABSTRACT

A public mobile advertisement mobile distribute device, which comprises a distribute mechanism; a total member mechanism, connected to the distribute mechanism; an advertisement agent mechanism, connected to the distribute mechanism; a coin mechanism, connected to the distribute mechanism; a group mechanism, connected to the distribute mechanism, where the advertisement agent mechanism and the distribute mechanism are coordinated to distribute the associated advertisement content according to different users in a group mechanism, and a coin mechanism provides a considerable reward to be used as necessary after the users anticipate the advertisement activity, so that efficacies of an increase advertisement proficiency, a widened advertisement service range and avoidance of a wasted communications resource may be achieved.

### FIELD OF THE INVENTION

The present invention relates to a public advertisement mobile distribute device, and particularly to such device where an advertisement agent mechanism and a distribute mechanism are coordinated to distribute the associated advertisement content according to different users in a group mechanism, and a coin mechanism provides a considerable reward to be used as necessary after the users anticipate the advertisement activity, so that efficacies of an increase advertisement proficiency, a widened advertisement service range and avoidance of wasted communications resource may be achieved.

### DESCRIPTION OF THE RELATED ART

The present invention relates to a public advertisement mobile distribute device, and particularly to such device where an advertisement agent mechanism and a distribute mechanism are coordinated to distribute the associated advertisement content according to different users in a group mechanism, and a coin mechanism provides a considerable reward to be used as necessary after the users anticipate the advertisement activity, so that efficacies of an increase advertisement proficiency, a widened advertisement service range and avoidance of wasted communications resource may be achieved.

With development of information, modern people have had intensively used the communications device such as PCs, notebooks, mobile phones or personal digital assistants (PDAs) for a connection to information in their ordinary life.

In the use course of a typical connection, some advertisement information may appear on or embedded in online on a webpage associated therewith, so that an advertisement promotion purpose may be achieved. However, the transmission of the advertisement has no any involvement with attribute, classification and regulation. The advertisement is placed within the webpage frame after the transmission, and thus the user might ignore the content in the webpage since he/she is so engaged with the intriguing content in the same webpage. Further, the user might sometimes be forced to receive irrelevant or boring advertisement information. This generally causes an antipathy of the users and thus the users consider the advertisement as a troublesome. Therefore, the advertisement agents generally receive a reversed effect without a satisfactory reward although they have paid so much cost. This lends to an information waste.

To overcome the demerits of the prior art, the inventor of the present invention sets forth a public advertisement mobile distribute device.

### SUMMARY OF THE INVENTION

It is, therefore, an object of the present invention to provide a public advertisement mobile distribute device, where an advertisement agent mechanism and a distribute mechanism are coordinated to distribute the associated advertisement content according to different users in a group mechanism, and a coin mechanism provides a considerable reward to be used as necessary after the users anticipate the advertisement activity, so that efficacies of an increased advertisement proficiency, a widened advertisement service range and avoidance of a wasted communications resource may be achieved.

To achieve the above object, the public mobile advertisement mobile distribute device comprises a distribute mechanism; a total member mechanism, connected to the distribute mechanism; an advertisement agent mechanism, connected to the distribute mechanism; a coin mechanism, connected to the distribute mechanism; and a group mechanism, connected to the distribute mechanism.

In an embodiment, the public mobile advertisement distribute mechanism, wherein the distribute mechanism, total member mechanism, advertisement agent mechanism and coin mechanism are combined at a management device.

In an embodiment, the public mobile advertisement distribute mechanism, wherein the distribute mechanism and group mechanism are connected through a communications server mechanism.

In an embodiment, the group mechanism comprises a plurality of group modules.

In an embodiment, each of the group modules comprises a game execution unit, a film execution unit, an activity execution unit, and a shopping execution unit.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention;

FIG. 2 is an schematic diagram of a basic architecture according to the present invention; and

FIG. 3 is a schematic block diagram according to the present invention.

### DESCRIPTION OF THE PREFERRED EMBODIMENTS

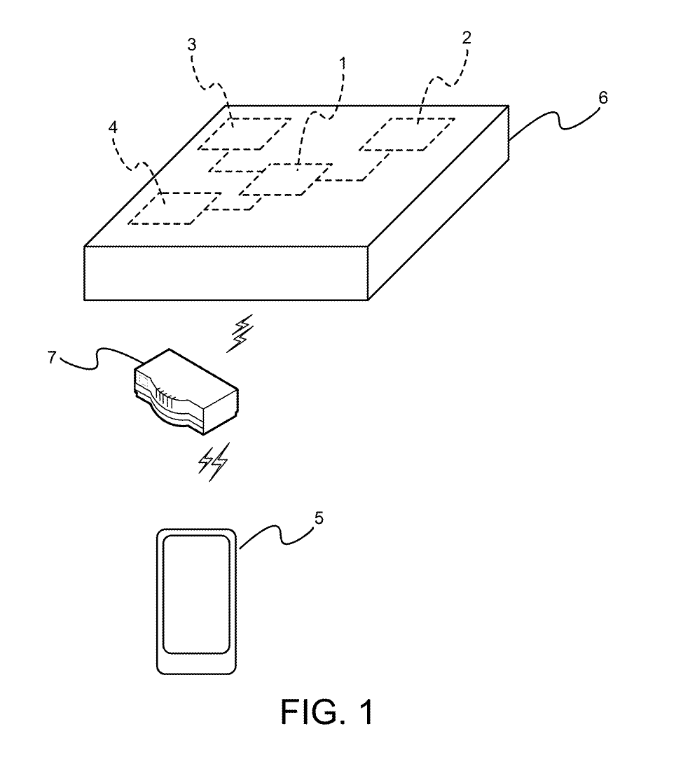

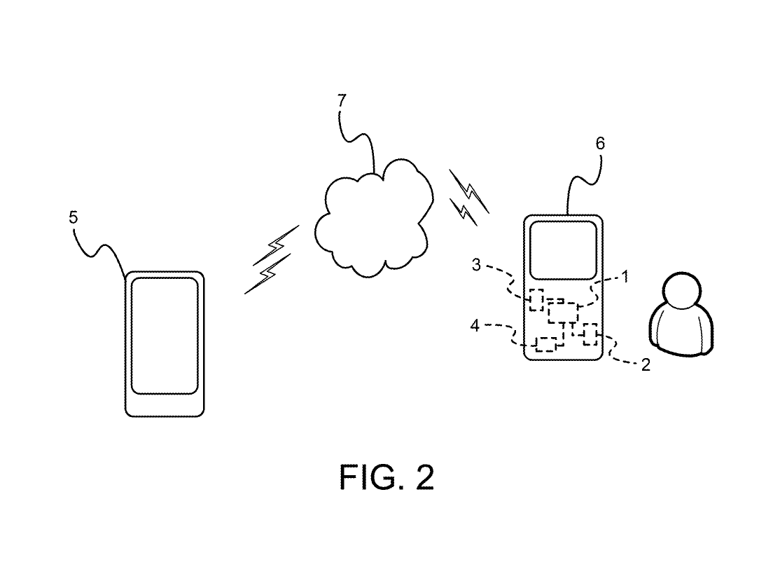

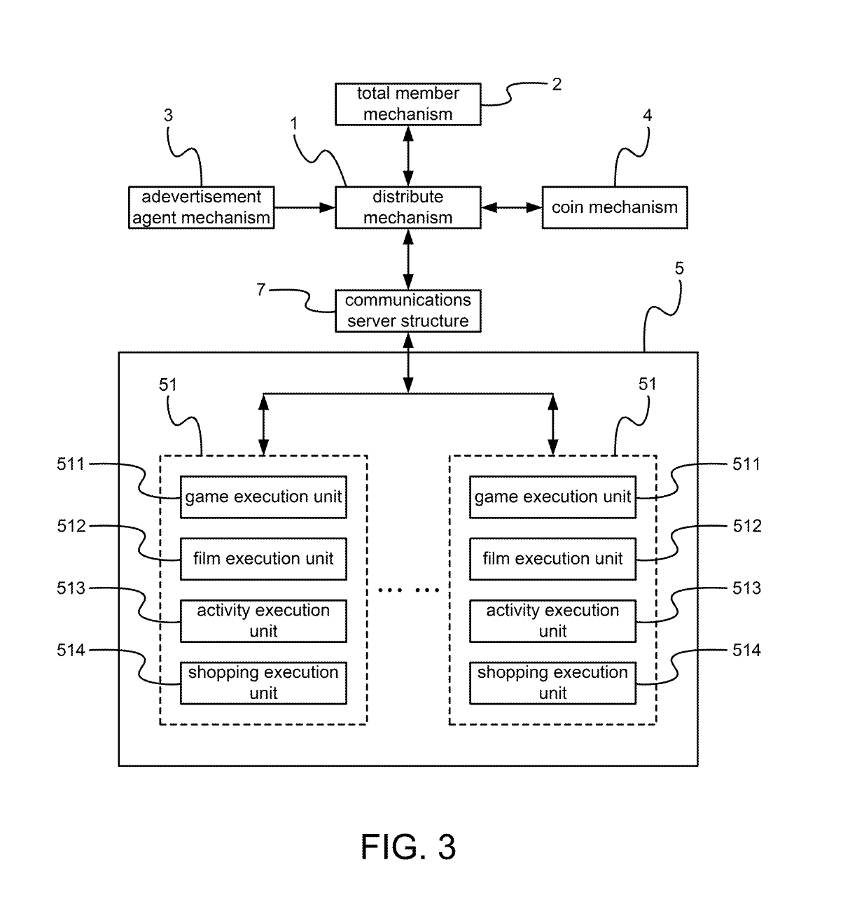

Referring to FIG. 1 to FIG. 3, a schematic diagram of a basic architecture according to the present invention, a schematic diagram of another basic architecture according to the present invention; and a schematic block diagram according to the present invention are shown therein.

As shown, the public advertisement mobile distribute device comprises a distribute mechanism 1, a total member mechanism 2, an advertisement agent mechanism 3, a coin mechanism 4, and a group mechanism 5. The advertisement mechanism 1, the total member mechanism 2, the advertisement agent mechanism 3, and the coin mechanism 4 are combined within a case 6.

The distribute mechanism 1 may be a controller chip.

The total member mechanism 2 is connected to the distribute mechanism 1.

The advertisement agent mechanism 3 is connected to the distribute mechanism 1.

The coin mechanism 4 is connected to the distribute mechanism 1.

The group mechanism 5 is connected to the distribute mechanism 1. The group mechanism 5 comprises a plurality of group modules 51, and each of which comprises a game execution unit 511, a film execution unit 512, an activity execution unit 513, a shopping execution unit 514. Further, a communications server mechanism 7 is disposed between the distribute mechanism 1 and the group mechanism. As such, a novel public mobile advertisement mobile distribute device is formed.

When the present invention is used, it is operated in a mobile device, and the distribute mechanism 1 is connected to the group mechanism 5 through a server mechanism 7, so that an advertisement agent may transmit a to-be-published advertisement information to the advertisement mechanism 1. Afterwards, the distribute mechanism 1 distributes the to-be-published advertisement information to each of the group modules 51 of the group mechanism 5 according to a classification of the to-be-published advertisement.

The group modules 51 may be classified into a song group, a movie group, a 3C group, an animation group, a game group, a magazine group, a traffic group, a fashion group, a medical group, a gormet group, a house group, a travel group, an appliance group, an education group, an appliance group, an indoorsman group, an indoorswoman group, and the like.

Therefore, the distribute mechanism may transmit the advertisement to all the classifications of the group module 51 according to the advertisement classifications recorded in the advertisement agent mechanism 3. In operation for a user, he/she applies for an official member and obtains an account, password or telephone number through the total member mechanism 2. Afterwards, the user may log in to the total member mechanism 2 according to the account and password. After logging to the total member mechanism 2, the user may enter the group modules 51 according to his/her demand. In this manner, the user may anticipate the activities recorded on the advertisement information by using the game execution unit 511, the film execution unit 512, the activity execution unit 513 or shopping execution unit 514. For example, the user plays the finger-guessing game, the score stealing game, or the like, by using the game execution game 511. The user conducts an A&Q activity by using the execution unit 513. The user directly purchases a merchandise by using the shopping execution unit 514. After the user participates the activity on the advertisement information, the user is given by the coin mechanism 4 with a proper amount of reward, where the reward may be a virtual coin or an actual coin. In this manner, the user may save the coin into the coin mechanism 4 or conduct a dealing activity, so that the user may be enabled to have a good interaction with the advertisement. As such, the efficacies of an increased advertisement proficiency, a widened advertisement service range, and avoidance of a communications resource waste.

In view of the above, the public advertisement mobile distribute device of the present invention may be used in a mobile device to overcome the demerits of the prior art, where an advertisement agent mechanism and a distribute mechanism are coordinated to distribute the associated advertisement content according to different users in a group mechanism, and a coin mechanism provides a considerable reward to be used as necessary after the users anticipate the advertisement activity, so that efficacies of an increased advertisement proficiency, a widened advertisement service range and avoidance of a wasted communications resource may be achieved. From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. A public mobile advertisement mobile distribute device, comprising:
a distribute mechanism;
a total member mechanism, connected to the distribute mechanism;
an advertisement agent mechanism, connected to the distribute mechanism;
a coin mechanism, connected to the distribute mechanism; and
a group mechanism, connected to the distribute mechanism.

2. The public mobile advertisement distribute mechanism as claimed in claim 1, wherein the distribute mechanism, total member mechanism, advertisement agent mechanism and coin mechanism are combined at a management device.

3. The public mobile advertisement distribute mechanism as claimed in claim 1, wherein the distribute mechanism and group mechanism are connected through a communications server mechanism.

4. The public mobile advertisement distribute mechanism as claimed in claim 3, wherein the group mechanism comprises a plurality of group modules.

5. The public mobile advertisement distribute mechanism as claimed in claim 4, wherein each of the group modules comprises a game execution unit, a film execution unit, an activity execution unit, and a shopping execution unit.
